(19) United States
(12) Patent Application Publication
(10) Pub. No.: US 2026/0130363 A1
(43) Pub. Date: May 14, 2026

(54) PEST ANT BAIT COMPOSITIONS AND METHODS

(71) Applicants: The United States of America, as Represented by the Secretary of Agriculture, Washington, DC (US); FORESIGHT SCIENCE & TECH. INC, Hopkinton, MA (US)

(72) Inventors: ROBERT K. VANDER MEER, NEWBERRY, FL (US); SATYA CHINTA, GAINESVILLE, FL (US)

(21) Appl. No.: 19/290,523

(22) Filed: Aug. 5, 2025

Related U.S. Application Data
(60) Provisional application No. 63/680,320, filed on Aug. 7, 2024.

(51) Int. Cl. A01N 25/00; A01N 33/10; A01N 43/14; A01N 65/00; A01P 7/04; A01P 19/00

(52) U.S. Cl. CPC A01N 25/006; A01N 33/10; A01N 43/14; A01N 65/00; A01P 7/04; A01P 19/00

(57) ABSTRACT

Compositions and methods for controlling fire ant infestations are described using a pesticide agent combined with a masking agent to overcome resistance of fire ants and increase insecticidal acceptance/efficacy are described. The masking agents used in preparing the compositions and methods of using them described are widely used ingredients not expected to affect human health.

### CROSS REFERENCE TO RELATED APPLICATIONS

This application claims the benefit of U.S. Provisional Application No. 63/680,320, titled “PEST ANT BAIT COMPOSITIONS AND METHODS” filed Aug. 7, 2024, which is incorporated herein by reference in its entirety.

### BACKGROUND OF THE INVENTION

Ants comprise 5% of the world's 100 worst invasive alien species and 28% of land invertebrates (see Lowe S., et al., (2000; Global Invasive Species Database (2024)). Global commerce ensures that these invasive pest species, including social insects, such as pest ant species will be distributed to compatible habitats throughout the world. For example, red imported fire ants (RIFA) have expanded their invasive range to Australia, Taiwan, China, Japan, and most recently, Italy. It is estimated that imported fire ants currently infest hundreds of millions of acres in the southern United States, and Puerto Rico, and climate change is promoting their movement northward.

Limited options exist for methods of controlling or eliminating invasive or native pest ant populations in urban and especially in rural environments. These limited options are due, in large part to the social structure of ant colonies. Over the past decades baits were found to be the most effective way to eliminate colonies. For RIFA, there are about 60 colonies per acre and each colony may contain 250,000 workers, a single or multiple queens, immatures (larvae), and male and female sexual forms. They live underground in a mound where the queen is protected by the workers against outside threats and from pathogens by their distribution of antimicrobial venom, which has multiple uses. Baits are considered the most effective method to control RIFA since blanket distribution of pesticides for fire ant control have been shown to cause environmental disasters.

Bait formulations were developed to take advantage of the efficient RIFA foraging system where workers search for and bring back food resources themselves or they will recruit additional workers to help retrieve large resources. The food is effectively distributed to all colony life-forms including the queen. Fire ant baits are composed of an active ingredient that needs to have delayed action, since foraging workers need time to ingest the material and distribute it to nestmates and the queen. In this case a tyramine or an N-methyl tyramine derivative dissolved in 10% sucrose solution, a RIFA phagostimulant, effectively controlled fire ant colonies that were maintained under laboratory conditions. However, when these formulations were applied to field colonies the formulation was ineffective, because worker ants would not ingest the formulation even with 10% sucrose. Higher sucrose concentrations were also ineffective.

There has not been a new fire ant bait active ingredient for >25 years. This is important because reliance on conventional/synthetic pesticides for control, can create environmental and health risks that are unacceptable. The use of broad-spectrum, persistent synthetic insecticides has significant drawbacks in that these chemicals also kill beneficial insects and may contaminate surface and ground water due to runoff as well as create other environmental concerns. Tyramine and N-methyl tyramine are naturally occurring compounds.

In prior work-(protected by U.S. Pat. No. 10,568,320 B2:) Vander Meer et al. uncovered new active ingredients and provides novel compositions and methods for using the insect neuromodulator tyramine and/or one or more derivatives thereof delivered to insect populations to control certain aspects of such populations.

There thus exists an industrial, commercial, and public ongoing need to develop efficacious, novel, and safe compositions and control methods to alleviate these problems, that are also cost-effective and easily adaptable for widespread use, particularly for the control of RIFA, but also for other invasive ants and insects.

### SUMMARY OF THE INVENTION

Described herein in various embodiments are compositions comprising combinations having an effective amount of a fire ant treating pesticide and a taste masking agent.

The composition taste masking agent is exemplified by cyclodextrins (alpha, beta and/or gamma) in one embodiment.

The fire ant treating compositions comprise combinations of taste masking agent and a pesticide which is exemplified by tyramine, N-methyl tyramine or mixtures thereof and their salts as the pesticide.

In one embodiment, a composition is exemplified wherein the pesticide is N-methyl tyramine or tyramine or their salts and a taste masking agent is (2-hydroxypropyl)-β-cyclodextrin.

Described herein in various embodiments are compositions comprising combinations of an effective amount of a fire ant treating pesticide and a taste masking agent wherein the pesticide has a structure:

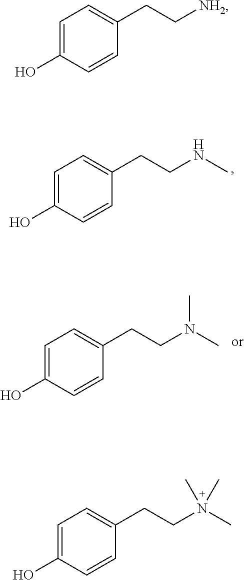

or salts thereof.

Described herein in various embodiments are compositions comprising combinations of an effective amount of a fire ant treating pesticide and a taste masking agent wherein the pesticide has a structure selected from:

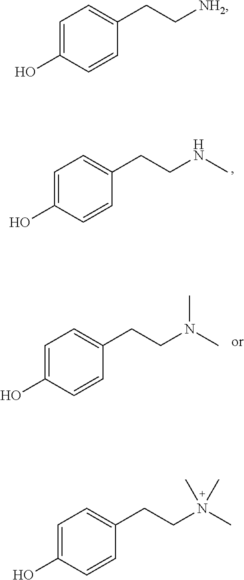

or salts thereof and the taste masking agent is selected from alpha cyclodextrin, beta cyclodextrin, gamma cyclodextrin, other natural cyclodextrins (cyclodextrins found in nature), chemically modified cyclodextrins or mixtures thereof. These combinations can further include a phagostimulant exemplified by a carbohydrate such as sucrose or an amino acid phagostimulant. In some embodiments a emulsified vegetable oil is used as a phagostimulant in the compositions and methods used herein.

Described herein in various embodiments are compositions comprising combinations of an effective amount of a fire ant treating pesticide and a taste masking agent, wherein, the pesticide has a structure:

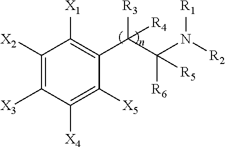

wherein R¹ and R² are independently H, C1 to C10 saturated or unsaturated alkyl, C1 to C10 acyl, aryl or hetero aryl; and X₁, X₂, X₃, X₄, X₅, R₃, R₄, R₅, and R₆ are independently H, hydroxy, C1 to C10 alkyl, C1 to C10 acyl or aryl or hetero aryl, halogen, amino, nitro, SH or a C1 to C10 acylated hydroxy group, and n=1-5, or salts thereof; wherein the taste masking agent is selected from alpha cyclodextrin, beta cyclodextrin, gamma cyclodextrin, other cyclodextrins found in nature, chemically modified cyclodextrins or mixtures thereof. These combinations can further include a phagostimulant exemplified by a carbohydrate (such as sucrose) or an amino acid or an emulsified vegetable oil.

Described herein in various embodiments are methods of controlling a population of fire ants, the method comprising delivering a composition comprising a combination of an effective amount of a fire ant pesticide and a taste masking agent. In one embodiment, the composition further comprises of at least one phagostimulant.

In an aspect, the method uses a fire ant controlling pesticide exemplified by tyramine or N-methyl tyramine or their salts combined with a taste masking agent. In one embodiment, the composition further comprises of at least one phagostimulant.

In an aspect, the method uses a composition which includes N-methyl tyramine and (2-hydroxypropyl)-β-cyclodextrin and sucrose as a phagostimulant. In one embodiment, the composition further comprises of at least one phagostimulant.

### BRIEF DESCRIPTION OF THE DRAWINGS

FIG. 1. shows N-methyl tyramine/cyclodextrin feeding experiment data results with a pesticide-taste masking agent composition, against queenright field collected fire ant colonies.

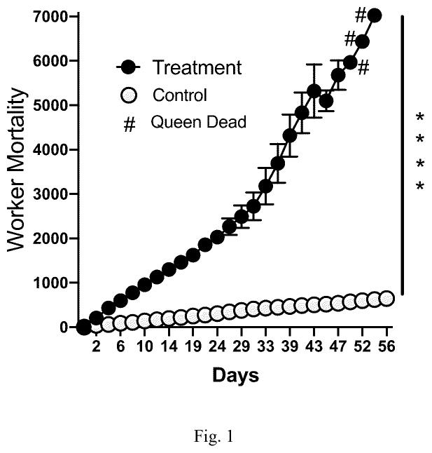

FIG. 2. illustrates the extreme difference in the response of fire ant colonies from laboratory reared versus fire ant field colonies.

FIG. 3. Increasing the sucrose concentration from 10% to 30% did not increase the acceptability of 1% N-Methyl Tyramine to field collected fire ant workers.

FIG. 4. Field collected fire ant workers were extremely sensitive to small increases in N-methyl Tyramine concentrations in choice bioassays where a high sucrose concentration (30%) was used.

FIG. 5. The choice test response of field collected fire ants to Tyramine and Tyramine plus cyclodextrin shows the positive effects of cyclodextrin.

FIG. 6. shows results of when fire ant colonies found naturally in a pasture were treated with a solution of N-methyl tyramine and Cyclodextrin dissolved in a 10% sucrose solution (N=5). The control colonies were treated only with the 10% sucrose solution (N=5).

### DETAILED DESCRIPTION

Described herein are compositions and methods of controlling pests using taste masking agents mixed with conventional or biological insecticides to increase insecticidal acceptance and/or efficacy.

In one embodiment the taste masking agent is a cyclodextrin. In one embodiment the taste masking agent is (2-hydroxypropyl)-β-cyclodextrin.

In one embodiment, the combination of active ingredient (AI) with taste masking agents can be directly applied as an insecticide.

In preferred embodiments, the taste masking agents exemplified by cyclodextrins employed in compositions and methods of controlling pests described herein do not adversely affect human health.

The cyclodextrin taste masking agents can be mixed with conventional or biological insecticides such as tyramine, N-methyl tyramine-HCl, etc. to increase insecticidal acceptance/efficacy. In one embodiment, the treatment composition is 0.1% N-methyl tyramine-HCl (4.8×10−4 mol) in 10% sucrose with 0.5M equivalent masking agent (2-hydroxypropyl)-β-cyclodextrin (0.045 mol).

In various aspects, the compositions include an effective amount of a compound selected from the group consisting of tyramine, one or more derivatives of tyramine, and combinations thereof combined with a taste masking agent exemplified by a cyclodextrin.

In various aspects, the compositions include an effective amount of a pesticide compound to control a red invasive fire ant colony exemplified by tyramine, one or more derivatives of tyramine, and combinations thereof combined with a taste masking agent exemplified by a cyclodextrin wherein the pesticide and the taste masking agent are in a ratio ranging from a molar ratio of 1:1 to 1:10,000 molar equivalents (or wherein pesticide:taste masking agent ratio ranges from 1:1 to 1:10,000 molar equivalents). In one embodiment, the composition further comprises pesticide and the taste masking agent are in a ratio ranging from a molar ratio of 1:1 to 1:10,000 molar equivalents (or pesticide:taste masking agent ratio ranges from 1:0.01 to 0.01:1 molar equivalents) combined with a phagostimulant.

In one embodiment, the composition further comprises of at least one phagostimulant. The effective amount in the composition is sufficient to deliver effective or prescribed dosages to the individual insects in the population and control a target population of social insects in one aspect. In another aspect, the invention provides methods of controlling a population of insects exemplified by fire ants using the aforementioned composition mixtures based on the combination of tyramine or one of its derivatives and cyclodextrin. The cyclodextrin used may be a natural cyclodextrin or a chemical derivative of a naturally occurring cyclodextrin. The composition optionally contains a phagostimulant, for example sucrose. The phagostimulant is preferably selected from a carbohydrate and/or an amino acid or mixtures thereof in one aspect. The method includes delivering the composition to a population of insects.

A pesticide composition in one embodiment is described comprising an effective amount of a red imported fire ant-treating pesticide and a taste-masking agent.

A taste masking agent in one embodiment of the composition above is cyclodextrin.

The pesticide in one embodiment of the composition above is tyramine.

A pesticide is selected from tyramine, a tyramine derivative, or a combination thereof in one embodiment of the composition above.

A taste masking agent is selected from α-cyclodextrin, β-cyclodextrin, γ-cyclodextrin, or a mixture thereof in various embodiments of the compositions above.

The cyclodextrin is a chemically modified cyclodextrin in one embodiment of the compositions above.

The chemically modified cyclodextrin in one embodiment of the compositions above is hydroxypropyl-β-cyclodextrin (HP-β-CD), Sulfobutyl ether-β-cyclodextrin, or a randomly-methylated-β-cyclodextrin.

The molar ratio of taste-masking agent to pesticide in one embodiment of the composition above are in about 1:1 molar ratio. The molar ratio of taste-masking agent to pesticide in one embodiment of the composition above are in about 100:1 molar ratio. The molar ratio of taste-masking agent to pesticide in one embodiment of the composition above are in about 1000:1 molar ratio. The molar ratio of taste-masking agent to pesticide in one embodiment of the composition above are in about 10000:1 molar ratio. The molar ratio of taste-masking agent to pesticide in one embodiment of the composition above are in about 100000:1 molar ratio. The molar ratio of taste-masking agent to pesticide in one embodiment of the composition above are in about 1:1 molar ratio. The molar ratio of taste-masking agent to pesticide in one embodiment of the composition above are in about 1:10 molar ratio. The molar ratio of taste-masking agent to pesticide in one embodiment of the composition above are in about 1:100 molar ratio. The molar ratio of taste-masking agent to pesticide in one embodiment of the composition above are in about 1:1000 molar ratio. The molar ratio of taste-masking agent to pesticide in one embodiment of the composition above are in about 1:10000 molar ratio.

The molar ratio of taste-masking agent to pesticide in one embodiment of the composition above are in a range of about 1:0.0001 to 0.01:1.

The taste-masking agent to the pesticide molar ratio in one embodiment of the composition above is about 5:1.

The pesticide is N-methyl tyramine and the taste masking agent is 2-hydroxypropyl-β-cyclodextrin in one embodiment of the composition above.

A pesticide composition in one embodiment of the compositions above with about 0.01 mol % to 10 mol % pesticide in about 10% aqueous sucrose with about 0.5M equivalent of cyclodextrin to pesticide.

A pesticide composition is described in one embodiment with about 0.01 mol % to 10 mol % pesticide in about 10% aqueous sucrose with about 0.5M cyclodextrin. A pesticide composition is described in one embodiment with about 0.01 mol % to 10 mol % pesticide in about 10% aqueous sucrose with about 0.0005 to 0.5M concentration range of a taste masking agent exemplified by cyclodextrin.

A pesticide composition in one embodiment with about 0.01 mol % to 10 mol % N-methyl tyramine-HCl in about 10% sucrose with about 0.5M equivalent of 2-hydroxypropyl-β-cyclodextrin to N-methyl tyramine-HCl.

A pesticide composition in one embodiment of the composition above with sucrose, an amino acid, or an emulsified vegetable oil used as phagostimulant.

A red imported fire ant-treating pesticide has a structure:

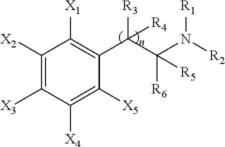

wherein R¹ and R² are independently H, C1 to C10 saturated or unsaturated alkyl, C1 to C10 acyl, aryl or hetero aryl; and X₁, X₂, X₃, X₄, X₅, R₃, R₄, R₅, and R₆ are independently H, hydroxy, C1 to C10 alkyl, C1 to C10 acyl or aryl or hetero aryl, halogen, amino, nitro, SH or a C1 to C10 acylated hydroxy group, and n=1-5, or salts thereof; and, wherein the taste masking agent is selected from alpha, beta and gamma cyclodextrin, chemically modified cyclodextrins or mixtures thereof.

A pesticide composition in one embodiment of the compositions above including at least one phagostimulant.

A pesticide composition in one embodiment of the compositions above wherein phagostimulant is selected from sucrose, an amino acid, or a emulsified vegetable oil or mixtures thereof.

A method of controlling a population of red imported fire ants in one embodiment is described by delivering a composition comprising an effective amount of a fire ant-treating pesticide and a taste masking agent.

A method of controlling a population of red imported fire ants in one embodiment of the method above wherein the taste masking agent is α-cyclodextrin, β-cyclodextrin, γ-cyclodextrin, or a mixture thereof.

A method of controlling a population of red imported fire ants in one embodiment of the methods above wherein the pesticide is N-methyl tyramine.

A method of controlling a population of red imported fire ants in one embodiment of the methods above wherein the pesticide is N-methyl tyramine hydrochloride, and the taste masking agent is 2-hydroxypropyl-β-cyclodextrin.

A method of controlling a population of red imported fire ants in one embodiment of the methods above wherein the fire ant treating pesticide has a structure:

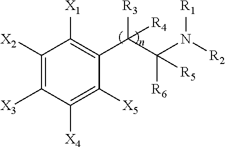

wherein R¹ and R² are independently H, C1 to C10 saturated or unsaturated alkyl, C1 to C10 acyl, aryl or hetero aryl; and X₁, X₂, X₃, X₄, X₅, R₃, R₄, R₅, and R₆ are independently H, hydroxy, C1 to C10 alkyl, C1 to C10 acyl or aryl or hetero aryl, halogen, amino, nitro, SH or a C1 to C10 acylated hydroxy group, and n=1-5, or salts thereof; and, wherein the taste masking agent is selected from alpha, beta and gamma cyclodextrin, chemically modified cyclodextrins or mixtures thereof.

In one embodiment of the methods above, a pesticide composition has about 0.01 mol % to 10 mol % pesticide in about 10 weight % aqueous sucrose with about 0.5M equivalent of cyclodextrin to pesticide. In one embodiment of the methods above, a pesticide composition has about 0.01 mol % to 10 mol % pesticide in about 10 weight % aqueous sucrose with about 0.5M cyclodextrin.

In one embodiment of the methods above, sucrose, an amino acid, or an emulsified vegetable oil is used as a phagostimulant.

In one embodiment of the methods above, molar ratio of taste-masking agent and pesticide are in about a 1:0.0001 to 0.0001:1 range.

To enhance ingestion and attraction of pests, other suitable additives in the compositions and methods described herein can include but are not limited to attractants, phagostimulants, or combinations thereof. In some embodiments an emulsified vegetable oil is used as a phagostimulant in the compositions and methods used herein. These additives can be incorporated within the composition in a dry or liquid form. Non-food carriers can also be used alone or combined with food materials or attractants that promote ingestion of the compositions described herein. Examples of non-food carriers suitable as additives include cellulose complexes, such as Biodac® (available from Kadant GranTek Inc., Granger, Ind.), sand, clay, silica, polyacrylic acid polymers, polyacrylimide acid polymers, diatomaceous earth, alginate, and wax.

In addition, the pesticidal compositions described herein can optionally include other components, such as other formulation enhancing additives. By way of non-limiting example, the composition can include preservatives, taste-altering additives, water-proofing agents, antioxidants, suspending agents, UV stabilizers, odor masking agents, and anti-microbial agents.

Biologically-based control compositions and methods for insect pests are described in U.S. Pat. No. 10,568,320 which is incorporated by reference herein in its entirety.

In other embodiments, the percentage of masking agent in the composition can range from a molar ratio of 1-10,000 molar equivalents relative to the pesticide molar equivalents. In other embodiments, the percentage of masking agent in the composition can range from 1 to 1,000 molar equivalents. In other embodiments, the percentage of masking agent in the composition can range from 1 to 100 molar equivalents. In other embodiments, the percentage of masking agent in the composition is in equimolar ratio to the pesticide or active agent. In other embodiments, the percentage of masking agent in the composition is in a molar ratio ranging from 1% to 1000% of the concentration of the pesticide or active agent. In other embodiments, the percentage of masking agent in the composition is in a molar ratio ranging from 1% to 500% of the concentration of the pesticide or active agent. In other embodiments, the percentage of masking agent in the composition is in a molar ratio ranging from 1% to 200% of the concentration of the pesticide or active agent.

The compositions and methods described herein in preferred embodiments reduce damage of a fire ant infestation by treatment with a composition comprising a combination of a pesticide and a masking agent. In various embodiments, the masking agent is exemplified by cyclodextrin (alpha, beta or gamma) or a chemically modified cyclodextrin exemplified by (2-Hydroxypropyl)-β-cyclodextrin, Methyl-β-cyclodextrin and the like. All the embodiments described above can optionally further comprise of at least one phagostimulant.

Also provided herein are systems and methods for a bait station for red imported fire ant (RIFA) control. In one embodiment a system provides a water-soluble AI (active ingredient) and masking agent. The active ingredient is N-methyl tyramine or its salt and the masking agent is 2-hydroxypropyl)-β-cyclodextrin.

Cyclodextrins are cyclic oligosaccharides wherein the central skeleton of cyclodextrin is composed of 1-4 linked carbon and oxygen atoms from 5 or more monosaccharide units exemplified by glucose units, leading to a structure exemplified by a hydrophobic cavity and hydrophilic rim. Some common examples of cyclodextrins are α (alpha)-cyclodextrin with 6 glucose subunits; β (beta)-cyclodextrin with 7 glucose subunits and γ (gamma)-cyclodextrin with 8 glucose subunits.

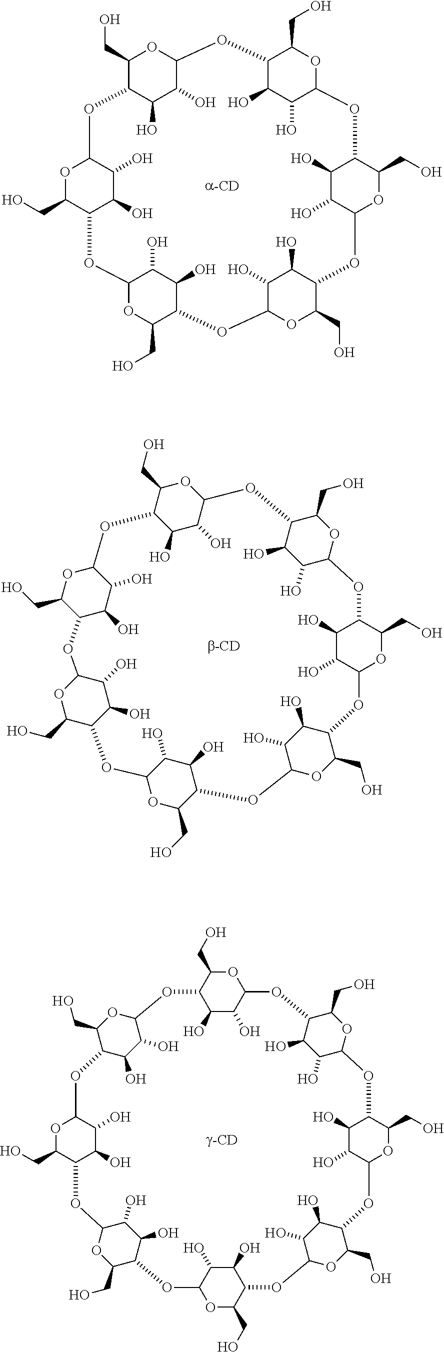

Cyclodextrins are derivatized by chemical modification. Examples of derivatized cyclodextrins are, hydroxypropyl-β-cyclodextrin (HP-β-CD), Sulfobutyl ether-β-cyclodextrin, randomly methylated-β-cyclodextrin, etc.

A variety of counter ions can be used to form salt complexes of the compositions described herein. In one aspect, an acid may be used to form a salt, such as HCl, HBr, or like mineral acids. In some embodiments, a suitable acid may include decanoic acid, hexanoic acid, mucic acid, octanoic acid. In other embodiments, a suitable acid may include acetic acid, adipic acid, L-ascorbic acid, L-aspartic acid, capric acid (decanoic acid), carbonic acid, citric acid, fumaric acid, galactaric acid, D-glucoheptonic acid, D-gluconic acid, D-glucuronic acid, glutamic acid, glutaric acid, glycerophosphoric acid, glycolic acid, hippuric acid, hydrochloric acid, DL-lactic acid, lauric acid, maleic acid, (−)-L-malic acid, palmitic acid, phosphoric acid, sebacic acid, stearic acid, succinic acid, sulfuric acid, (+)-L-tartaric acid, or thiocyanic acid. In other embodiments, a suitable acid may include alginic acid, benzenesulfonic acid, benzoic acid, (+)-camphoric acid, caprylic acid (octanoic acid), cyclamic acid, dodecyl sulfuric acid, ethane-1,2-disulfonic acid, ethanesulfonic acid, 2-hydroxy-, gentisic acid, glutaric acid, 2-oxo-, isobutyric acid, lactobionic acid, malonic acid, methanesulfonic acid, naphthalene-1,5-disulfonic acid, naphthalene-2-sulfonic acid, 2-naphthoic acid, 1-hydroxy-, nicotinic acid, oleic acid, orotic acid, oxalic acid, pamoic acid, (embonic acid), propionic acid, (−)-L-pyroglutamic acid, or p-toluenesulfonic acid. In yet other embodiments, a suitable acid may include acetic acid, 2,2-dichloro-, benzoic acid, 4-acetamido-, (+)-camphor-10-sulfonic acid, caproic acid (hexanoic acid), cinnamic acid, formic acid, hydrobromic acid, DL-mandelic acid, nitric acid, salicylic acid, salicylic acid, 4-amino-, or undecylenic acid (undec-10-enoic acid). Mixtures of one or more such acids can also be used. Other means employed can include metals (e.g., alkali metals, alkali earth metals and transition metals). Non-limiting examples of cationic counter ions include zinc, calcium, aluminum, zinc, barium, magnesium, and copper. Non-limiting examples of anionic counter ions include phosphate, carbonate, and fatty acids. Counter ions may be, for example, monovalent, divalent, or trivalent. Other counter ions are known in the art and can be used in the embodiments described herein.

The compositions and formulations described herein are useful as biopesticide compositions in the treatment, amelioration, controlling and/or prevention of a RIFA infestation. Infestations are usually in the form of a colony. The term “treatment” refers to both pesticide treatment for extermination or control of an infestation and prophylactic or preventative measures. Treatment includes the application or administration of the composition preferably in a formulation to a colony to control, alleviate, relieve, alter, remedy, ameliorate, or affect the RIFA infestation.

The term “amelioration” as used herein refers to any improvement or treatment of the infestation of a plant having an infection or other pathological condition as specified herein, by the administration of active ingredient-taste masking agent mixture composition according to the compositions and methods described herein to an infested subject environment in need thereof. Such an improvement may also be seen as a slowing, arresting or stopping of the progression of an infection in the plant. The term “prevention” as used herein means compositions and methods described herein for prevention or to protect the plant, the avoidance of the occurrence or re-occurrence of a plant having an infection as specified herein below, by the administration of a pesticide-masking agent combination composition according to the compositions and methods of treatment described herein.

Taste masking agent is one that works by reducing the interaction between the drug and receptors of a pest organism by masking the unpleasant taste of a compound. Examples described herein include cyclodextrins.

The term “controlling” refers to controlling an infestation. In various embodiments, a fire ant or RIFA colony (Red Imported Fire Ant) infestation which is embodied for example by the presence and spread of Solenopsis invicta, an invasive ant species known for its painful, venomous stings and its ability to damage ecosystems and infrastructure. These ants are aggressive and can quickly colonize new areas, causing significant problems for humans, animals, and agriculture. An ant colony is a population of ants, typically from a single species, capable of maintaining their complete lifecycle. They form colonies with large populations, and mature colonies can have tens of thousands of colony members; for example large colonies may have between 200,000 and 300,000 workers. A colony maybe in a polygyne (multiple queen) fire ant social form that may contain hundreds of colonies and each colony will have multiple inseminated queens. A single polygyne queen's egg laying rate is negatively affected by additional queens in the colony. Workers in polygyne colonies are not aggressive to workers from other colonies in the polygyne population. Regardless of polygyne and monogyne social form, baits developed for fire ant control are effective against both social form.

The term “effective amount” of a composition, compound or property as provided herein is meant such amount as is capable of performing the function of the compound or property for which an effective amount is expressed. As is pointed out herein, the exact amount required will vary from process to process, depending on recognized variables such as the compounds employed, and various internal and external conditions observed as would be interpreted by one of ordinary skill in the art. Thus, it is not possible to specify an exact “effective amount,” though preferred ranges have been provided herein. An appropriate effective amount may be determined, however, by one of ordinary skill in the art using only routine experimentation.

The term “optional” or “optionally” means that the subsequently described event or circumstance may or may not occur or may not be sufficient enough and that the description includes instances in which said event or circumstance occurs and instances where it does not. For example, the phrase “optionally comprising a defoaming agent” means that the composition may or may not contain a defoaming agent and that this description includes compositions that contain and do not contain a foaming agent.

The term “substantially pure” refers to a formulation that is at least about 90% (e.g., at least 90%) in purity weight/weight of a total composition. In a more preferred embodiment, the purity is at least about 95% (e.g., at least about 95%) weight-to-weight, or at least about 98% (e.g., at least about 98%) purity.

The amount of active ingredient can vary with the desired application and insect to be controlled. In a preferred embodiment of the invention, the compositions exemplified by a combination of a taste masking agent and pesticide described herein is dissolved in the formulation to a concentration range of about 0.005 to 15% w/w, preferably about 0.05 to 5% w/w, more preferably about 0.1% to 3% w/w and most preferably, about 0.2% to 1.1% w/w. A typical treatment dosage may range from about 0.1 μg/kg of weight of treated pest aggregate body mass to up to about 50 gm/kg or more, depending on the factors mentioned above. The weight of treated pest aggregate body mass is the combined weight of body mass of social insects treated by a composition described herein. For example, a 500 mg/kg treatment dose means about 500 mg of an exemplified composition containing a combination of N-methyl tyramine-HCl plus (2-hydroxypropyl)-β-cyclodextrin) plus sucrose used to treat a RIFA infestation, wherein the combined body mass of the RIFAs (insects) treated is about one kilogram (kg). In one embodiment, the weight of 200,000 workers in a colony is about 150 g. In specific embodiments, the dosage may range from 1.0 μg/kg up to about 20,000 mg/kg of weight of treated pest aggregate body mass, the dosage may range from 1.0 μg/kg up to about 2000 mg/kg of weight of treated pest aggregate body mass, optionally from 10 μg/kg up to about 10 mg/kg or from 100 μg/kg up to about 500 mg/kg or from 100 μg/kg up to about 15 gm/kg of weight of treated pest aggregate body mass or from 100 μg/kg up to about 50 gm/kg of weight of treated pest aggregate body mass.

Accordingly, in one aspect, provided herein are compositions with such formulations, and application forms prepared from them, are provided as pesticidal agents, such as drench, drip, direct injection and spray liquors, comprising the compositions described herein. The application forms may comprise further pesticidal agents, and/or activity-enhancing adjuvants such as penetrants, examples being vegetable oils such as, for example, rapeseed oil, sunflower oil, alkyl esters of vegetable fatty acids, such as rapeseed oil or soybean oil methyl esters, or alkanol alkoxylates, and/or spreaders such as, for example, alkylsiloxanes and/or salts, examples being organic or inorganic ammonium or phosphonium salts, examples being ammonium sulphate or diammonium hydrogen phosphate, and/or retention promoters such as dioctyl sulphosuccinate or hydroxypropylguar polymers and/or humectants such as glycerol and/or fertilizers such as ammonium, potassium or phosphorous fertilizers, for example.

Examples of typical formulations include water-soluble liquids (SL), emulsifiable concentrates (EC), emulsions in water (EW), emulsions in vegetable oils, suspension concentrates (SC, SE, FS, OD), water-dispersible granules (WG), granules (GR) and capsule concentrates (CS); these and other possible types of formulation are described, for example, by Crop Life International and in Pesticide Specifications, Manual on development and use of FAO and WHO specifications for pesticides, FAO Plant Production and Protection Papers—173, prepared by the FAO/WHO Joint Meeting on Pesticide Specifications, 2004, ISBN: 9251048576 described therein are incorporated by reference herein in their entirety. The formulations may comprise active agrochemical compounds other than one or more active compounds of the compositions described herein.

The formulations or application forms in question can comprise auxiliaries, such as extenders, solvents, spontaneity promoters, carriers, emulsifiers, dispersants, frost protectants, biocides, thickeners and/or other auxiliaries, such as adjuvants, for example. An adjuvant in this context is a component which enhances the biological effect of the formulation, without the component itself having a biological effect. Examples of adjuvants are agents which promote the retention, spreading, attachment to leaf surfaces.

These formulations are produced in a known manner, for example by mixing the active compounds with auxiliaries such as, for example, extenders, solvents and/or solid carriers and/or further auxiliaries, such as, for example, surfactants. The formulations are prepared either in suitable plants or elsewhere or on location before or during the application.

Suitable for use as auxiliaries are substances which are suitable for imparting to the formulation of the active compound or the application forms prepared from these formulations particular properties such as certain physical, technical and/or biological properties.

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly) ethers, the unsubstituted and substituted amines, amides, lactams (such as N-alkylpyrrolidones) and lactones, the sulphones and sulphoxides (such as dimethyl sulphoxide).

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar a protic solvents such as dimethylformamide and dimethyl sulphoxide, and also water. Preferred auxiliary solvents are selected from the group consisting of acetone and N,N′-dimethylformamide.

All suitable carriers may in principle be used. Suitable carriers are in particular: for example, ammonium salts and ground natural minerals such as kaolins, clays, talc, chalk, quartz, attapulgite, montmorillonite or diatomaceous earth, and ground synthetic minerals, such as finely divided silica, alumina and natural or synthetic silicates, resins, waxes and/or solid fertilizers. Mixtures of such carriers may likewise be used. Carriers suitable for granules include the following: for example, crushed and fractionated natural minerals such as calcite, marble, pumice, sepiolite, dolomite, and synthetic granules of inorganic and organic meals, and also granules of organic material such as sawdust, paper, coconut shells, maize cobs and tobacco stalks.

Examples of emulsifiers and/or foam-formers, dispersants or wetting agents having ionic or nonionic properties, or mixtures of these surface-active substances, are salts of polyacrylic acid, salts of lignosulphonic acid, salts of phenolsulphonic acid or naphthalenesulphonic acid, polycondensates of ethylene oxide with fatty alcohols or with fatty acids or with fatty amines, with substituted phenols (preferably alkylphenols or arylphenols), salts of sulphosuccinic esters, taurine derivatives (preferably alkyltaurates), phosphoric esters of polyethoxylated alcohols or phenols, fatty acid esters of polyols, and derivatives of the compounds containing sulphates, sulphonates and phosphates, examples being alkyl aryl polyglycol ethers, alkylsulphonates, alkyl sulphates, arylsulphonates, protein hydrolysates, lignin-sulphite waste liquors and methylcellulose. The presence of a surface-active substance is advantageous if one of the active compounds and/or one of the inert carriers is not soluble in water and if application takes place in water. Preferred emulsifiers are alkyl aryl polyglycol ethers.

Further auxiliaries that may be present in the formulations and in the application forms derived from them include colorants such as inorganic pigments, examples being iron oxide, titanium oxide, Prussian Blue, and organic dyes, such as alizarin dyes, azo dyes and metal phthalocyanine dyes, and nutrients and trace nutrients, such as salts of iron, manganese, boron, copper, cobalt, molybdenum and zinc.

Stabilizers, such as low-temperature stabilizers, preservatives, antioxidants, light stabilizers or other agents which improve chemical and/or physical stability may also be present. Additionally present may be foam-formers or defoamers.

As used herein, the term “about” is defined as plus or minus ten percent of a recited value. For example, about 1.0 g means 0.9 g to 1.1 g.

Unless otherwise explained, all technical and scientific terms used herein have the same meaning as commonly understood by one of ordinary skill in the art to which this disclosure belongs. The singular terms “a”, “an”, and “the” include plural referents unless context clearly indicates otherwise. Similarly, the word “or” is intended to include “and” unless the context clearly indicate otherwise.

It will be obvious to those skilled in the art that such embodiments are provided by way of example only. Numerous variations, changes, and substitutions will occur to those skilled in the art without departing from the embodiments of the claims. Various alternatives to the embodiments of the claims described herein may be employed in practicing the use of compositions and methods of treatment described herein. It is intended that the included claims define the scope of the various compositions and methods of treatment described herein and that methods and structures within the scope of these claims and their equivalents are covered thereby. All publications, patents, and patent applications mentioned in this specification are herein incorporated by reference to the same extent as if each individual publication, patent, or patent application was specifically and individually indicated to be incorporated by reference.

The term “consisting essentially of” excludes additional method (or process) steps or composition components that substantially interfere with the intended activity of the method (or process) or composition. This term may be substituted for inclusive terms such as “comprising” or “including” to more narrowly define any of the disclosed embodiments or combinations/sub-combinations thereof. Furthermore, the exclusive term “consisting of” is also understood to be substitutable for these inclusive terms.

The formulations described herein are useful as pesticide compositions in the control, treatment, amelioration, extermination and/or prevention of pest infestations as described herein. Treatment includes the application or administration of the formulation to a space, area, one or more objects in which pests are present with the purpose to control, alleviate, relieve, alter, remedy, ameliorate, improve, eliminate or affect the pest infestation, or the predisposition toward the pest infestation.

The term pesticide describes any substance or mixture of substances intended for preventing, destroying, repelling, or mitigating any pest.

Chemical modification as used herein refers to preparing compounds created by modifying a parent molecule through chemical reactions for example by synthetic reactions. These modifications can involve replacing atoms or groups of atoms, leading to new compounds with potentially altered properties.

The term alkyl as used herein refers to an alkyl group which consists of carbon and hydrogen atoms, forming a linear chain, cyclic or branched structure or group derived from an alkane by removing a hydrogen atom. Common alkyl groups include methyl (CH3), ethyl (CH3CH2), propyl (CH3CH2CH2), and butyl (CH3CH2CH2CH2). The alkyl groups described herein may optionally have one or more unsaturated double bonds.

The term aryl as used herein refers to a functional group or substituent derived from an aromatic ring, most commonly a hydrocarbon, where one hydrogen atom has been removed. The simplest aryl group is the phenyl group (C₆H₅), derived from benzene. The aromatic rings might be fused in aryl groups such as bicyclic, tricyclic, etc. naphthyl, anthracene derived aryl groups. A hetero aryl group is an aromatic group bearing a ring atom that is not a carbon atom such as nitrogen, sulfur or oxygen atoms. Examples of heteroaromatic groups are pyridyl, indolyl, etc.

The term acyl as used herein refers to a moiety which contains a double-bonded oxygen atom to a carbon and an alkyl or aryl group bonded to the carbon (R—C═O) or hydrogen in the case where the acyl is a formyl group (H—C═O). Examples of acyl groups include esters, amides, etc. An acylated hydroxy group is a chemical structure where a hydroxy group (—OH) is bonded to an acyl group (R—CO—). This reaction, known as acylation, introduces an acyl moiety to the molecule, typically replacing the hydrogen of the hydroxyl group.

Mol percent (Mol %) also known as amount/amount percent (n/n) %, is a way to express the concentration of a component in a mixture. It represents the percentage of moles of a specific substance relative to the total number of moles in the mixture.

Weight percent is mass percentage of a solution component defined as the ratio of the component's mass to the solution's mass, expressed as a percentage

The term “amelioration” as used herein refers to any improvement of the pest infestation as specified herein below, by the administration of a pesticide-taste masking combination construct according to the compositions and methods described herein. Such an improvement may also be seen as a slowing or stopping of the progression of a pest infestation. The term “prevention” as used herein means the avoidance of the occurrence or re-occurrence of a pest infestation, by the administration of the compositions and methods of treatment described herein to a subject ant colony in need thereof.

The term “phagostimulant” as used herein refers to a substance that stimulates feeding or increases food intake in an organism, often by triggering chemoreceptors. In simpler terms, it's a flavor or chemical that makes an animal want to cat more.

Described below are abbreviations used herein.
RIFA—Entomological Society of America's official abbreviation for Solenopsis invicta. AKA red imported fire ant,
AI—active ingredient,
μg—microgram . . .
M—molar concentration (also called amount-of-substance concentration or molarity) is the number of moles of solute per liter of solution (mol/L, M).
w/w—weight/weight
mg—milligram
kg—kilogram
gm—gram

### Examples

Having now generally described the compositions, methods of treatment and other embodiments described herein, the same will be better understood by reference to certain specific examples, which are included herein only to further illustrate the embodiments and are not intended to limit the scope of the same as defined by the claims.

N-methyl tyramine feeding experiment with a taste masking agent, against queenright field collected fire ant colonies:

Queen right colonies were collected from field sites in the Gainesville, FL area. They were set up in the laboratory in standard colony rearing trays (40×50×6 cm). They were initially fed crickets and 10% sucrose in water. The number of workers in each colony were estimated and the six field colonies were segregated into treatment and control groups. The treatment colonies had 5,000, 20,000, and 25,000 workers. The three control colonies contained 10,000, 15,000, and 20,000 worker ants. All colonies had copious amounts of brood. The treatment colonies were fed N-methyl tyramine-HCl (0.9 gr, 0.0048 mol, 53.4 mM and (2-hydroxypropyl)-β-cyclodextrin (46.53 g, 0.045 mol, 0.5M concentration) dissolved of previously prepared 10% sucrose stock (9 gr in 90 ml water) provided in disposable culture tubes (16×150 mm) plugged with cotton balls. The control colonies were fed (2-hydroxypropyl)-β-cyclodextrin (46.53 g, 0.045 mol, 0.5M concentration) dissolved of previously prepared 10% sucrose stock (9 gr in 90 ml water) provided in disposable culture tubes (16×150 mm) plugged with cotton balls.

The treatment and control tubes were replenished as needed over a period of 8 weeks. Mortality was recorded every other day. Starting queen weights for treatments were 22.8 mg, 20.8 mg, and 20.4 at time zero. Queen weight for controls were 19.4 mg, 19.0 mg, and 18.3 mg at time zero. Queen weights were measured every 10 days throughout the experiment. After 7 weeks worker mortality was 40, 30, and 32% and significantly different from the control with mortality rates of 3.8, 5.1 and 3.6% (****: P<0.0001). Importantly, all 3 colony queens died. Queen deaths occurred during weeks 7 and 8. Our results show excellent formulation acceptance and transfer to workers and the colony queen. If the queen dies the colony is functionally dead. The control colonies remained healthy with all queens surviving for the duration of the experiment. These results support effectiveness of the active ingredient at 10-fold lower concentration than previously presented (1% N-methyl tyramine in 10% sucrose in combination with 0.5M β-cyclodextrin). This larger window of effective AI concentration is important for successful field evaluations.

Statistical data: The graphics and statistical analyses were carried out using GraphPad/Prism.

| | |
|---|---|
| “Paired t test” | |
| “ P value” | <0.0001 |
| “ P value summary” | **** |
| “ Significantly different (P < 0.05)?” | Yes |
| “ One- or two-tailed P value?” | Two-tailed |
| “ t, df” | “t = 6.334, df = 23” |
| “ Number of pairs” | 24 |
| “How big is the difference?” | |
| “ Mean of differences (D − C)” | −2367 |
| “ SD of differences” | 1831 |
| “ SEM of differences” | 373.7 |
| “ 95% confidence interval” | “−3140 to −1594” |
| “ R squared (partial eta squared)” | 0.6356 |
| “How effective was the pairing?” | |
| “ Correlation coefficient (r)” | 0.9654 |
| “ P value (one tailed)” | <0.0001 |
| “ P value summary” | **** |
| “ Was the pairing significantly effective?” | Yes |
| “Paired t test” | |
| “ P value” | <0.0001 |
| “ P value summary” | **** |
| “ Significantly different (P < 0.05)?” | Yes |

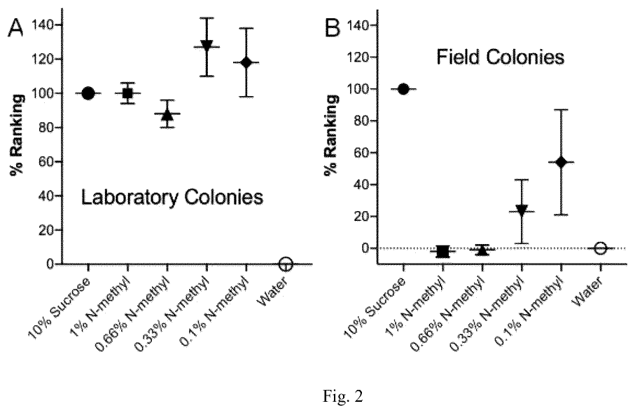

FIG. 2 illustrates the extreme difference in the response of fire ant workers from laboratory reared versus fire ant workers from field colonies. All N-methyl-tyramine samples are dissolved in 10% sucrose. The positive phagostimulant standard is 10% sucrose. The mean and standard error of 3 replicates are shown for controls and treatments. All results using Laboratory collected fire ants (FIG. 2A) were not significantly different from the result for the positive control, 10% sucrose (set to 100), but they were different from the neutral/negative control, water (set to 0). All results using field collected fire ants (FIG. 2B) were not significantly different from the result for water—the negative control.

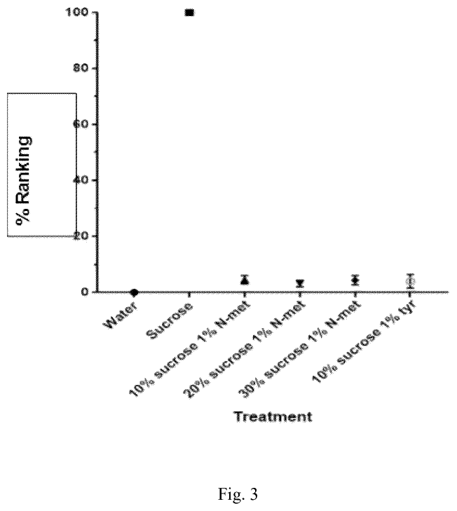

FIG. 3 illustrates increasing the sucrose concentration from 10% to 30% did not increase the acceptability of 1% N-Methyl Tyramine to field collected fire ant workers. 1% Tyramine (Tyr) in 10% sucrose solution was also not acceptable to field collected fire ant workers, similar to N-methyl tyramine. The control Sucrose is at 10% concentration and is set at 100% in the choice bioassay. The response to water was set to 0%.

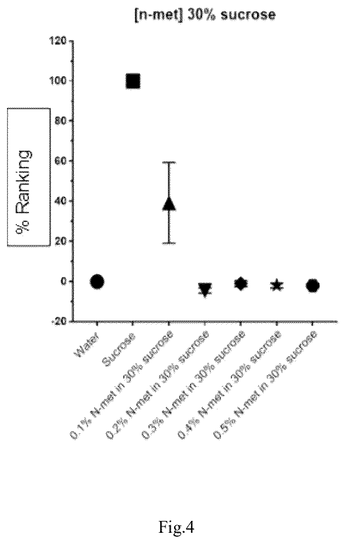

FIG. 4 shows field collected fire ant workers were extremely sensitive to small increases in N-methyl Tyramine concentrations in choice bioassays where a high sucrose concentration (30%) was used. The 0.1% concentration had a mean percent ranking of about 38%. Increasing this concentration to 0.2% resulted in total rejection by field collected fire ant workers. This result was further confirmed at 0.3%, 0.4%, and 0.5%. These data illustrate how negatively sensitive the fire ant workers are to the taste of low concentrations of N-methyl Tyramine.

FIGS. 2, 3 and 4 illustrate the negative reaction of field collected fire ant workers to tyramine and N-methyl Tyramine. Since field fire ant colonies are the target, ways to mask the distastefulness of tyramine and derivatives are needed.

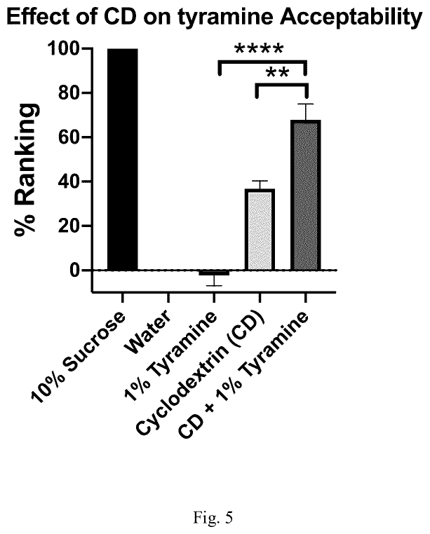

The response of field collected fire ants in a choice test are shown in FIG. 5. CD is cyclodextrin at 0.5 molar. Cyclodextrin is a complex carbohydrate and shows some inherent phagostimulant activity. 1% tyramine is completely rejected by field collected fire ants. However, 1% tyramine with 0.5 molar cyclodextrin is consumed significantly more than cyclodextrin by itself, and the combination is even more significantly different from 1% tyramine by itself.

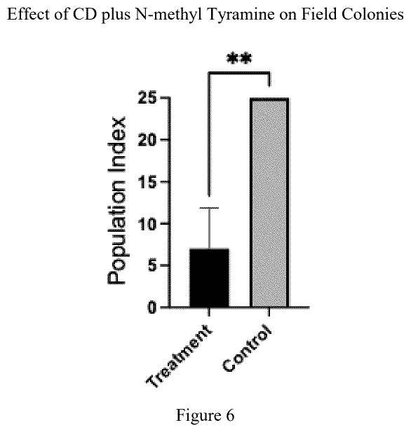

FIG. 6. Fire ant colonies found naturally in a pasture were treated with a solution of N-methyl tyramine and Cyclodextrin dissolved in a 10% sucrose solution (N=5). The control colonies were treated only with the 10% sucrose solution (N=5). All colonies had a Population Index (PI) value of 25 (the maximum possible). PI values for the controls and treatments were recorded once a week for a total of 6 weeks. The mean PI± the Standard Error are shown in FIG. 6 for week 6 post treatment. Comparison of the PI results for Treatment and the Control colonies was carried out using an unpaired two-tailed t test (t=3.674, df=8), P=0.0063 (N=5). In addition, F-test comparison of variances between treatments and controls also showed significant differences, P<0.0001.

We claim:

1. A pesticide composition comprising:
an effective amount of a red imported fire ant-treating pesticide and a taste-masking agent.

2. The composition of claim 1 wherein, the taste masking agent is cyclodextrin.

3. The composition of claim 1 wherein, the pesticide is tyramine.

4. The composition of claim 1, wherein the pesticide is selected from tyramine, a tyramine derivative, or a combination thereof.

5. The composition of claim 1 wherein, the taste masking agent is selected from α-cyclodextrin, β-cyclodextrin, γ-cyclodextrin, or a mixture thereof.

6. The composition of claim 2, wherein the cyclodextrin is a chemically modified cyclodextrin.

7. The composition of claim 6, wherein the chemically modified cyclodextrin is hydroxypropyl-β-cyclodextrin (HP-β-CD), Sulfobutyl ether-β-cyclodextrin, or a randomly-methylated-B-cyclodextrin.

8. The composition of claim 1, wherein the molar ratio of taste-masking agent and pesticide are in a 1:1 molar ratio.

9. The composition of claim 1, wherein the molar ratio of taste-masking agent and pesticide are in a range of about 1:0.0001 to 0.01:1.

10. The composition of claim 1, wherein molar ratio of the taste-masking agent to the pesticide is about 5:1.

11. The composition of claim 1, wherein the pesticide is N-methyl tyramine and the taste masking agent is 2-hydroxypropyl-β-cyclodextrin.

12. The composition of claim 1, wherein the pesticide composition is about 0.01 mol % to 10 mol % pesticide in about 10% aqueous sucrose with about 0.5M equivalent of cyclodextrin to pesticide.

13. The composition of claim 12, wherein the pesticide composition is about 0.01 mol % to 10 mol % N-methyl tyramine-HCl in about 10% sucrose with about 0.5M equivalent of 2-hydroxypropyl-β-cyclodextrin to N-methyl tyramine-HCl.

14. The composition of claim 1, further comprising sucrose, an amino acid, or an emulsified vegetable oil is used as a phagostimulant.

15. The composition of claim 1, wherein the red imported fire ant-treating pesticide has a structure: 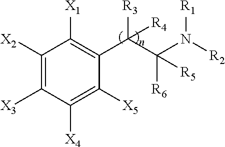
wherein R¹ and R² are independently H, C1 to C10 saturated or unsaturated alkyl, C1 to C10 acyl, aryl or hetero aryl; and X₁, X₂, X₃, X₄, X₅, R₃, R₄, R₅, and R₆ are independently H, hydroxy, C1 to C10 alkyl, C1 to C10 acyl or aryl or hetero aryl, halogen, amino, nitro, SH or a C1 to C10 acylated hydroxy group, and n=1-5, or salts thereof; and,
wherein the taste masking agent is selected from alpha, beta and gamma cyclodextrin, chemically modified cyclodextrins or mixtures thereof.

16. The composition of claim 15, further including at least one phagostimulant.

17. The composition of claim 16 wherein the phagostimulant is selected from sucrose, an amino acid, or a emulsified vegetable oil or mixtures thereof.

18. A method of controlling a population of red imported fire ants, the method comprising delivering a composition comprising an effective amount of a fire ant-treating pesticide and a taste masking agent.

19. The method of claim 18, wherein the taste masking agent is α-cyclodextrin, β-cyclodextrin, γ-cyclodextrin, or a mixture thereof.

20. The method of claim 18, wherein the pesticide is N-methyl tyramine.

21. The method of claim 18, wherein the pesticide is N-methyl tyramine hydrochloride, and the taste masking agent is 2-hydroxypropyl-β-cyclodextrin.

22. The method of claim 18, wherein the fire ant treating pesticide has a structure: 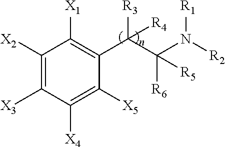
wherein R¹ and R² are independently H, C1 to C10 saturated or unsaturated alkyl, C1 to C10 acyl, aryl or hetero aryl; and X₁, X₂, X₃, X₄, X₅, R₃, R₄, R₅, and R₆ are independently H, hydroxy, C1 to C10 alkyl, C1 to C10 acyl or aryl or hetero aryl, halogen, amino, nitro, SH or a C1 to C10 acylated hydroxy group, and n=1-5, or salts thereof; and,
wherein the taste masking agent is selected from alpha, beta and gamma cyclodextrin, chemically modified cyclodextrins or mixtures thereof.

23. The method of claim 18, wherein the pesticide composition is about 0.01 mol % to 10 mol % pesticide in about 10 weight % aqueous sucrose with about 0.5M equivalent of cyclodextrin to pesticide.

24. The method of claim 19, further comprising sucrose, an amino acid, or an emulsified vegetable oil as a phagostimulant.

25. The method of claim 19, wherein the molar ratio of taste-masking agent and pesticide are in about a 1:0.0001 to 0.01:1 range.
